(19) United States
(12) Patent Application Publication
(10) Pub. No.: US 2026/0222385 A1
(43) Pub. Date: Jul. 30, 2026

(54) WI-FI MULTI-AP COORDINATION WITH MAC ADDRESS ROTATION

(71) Applicant: Cisco Technology, Inc., San Jose, CA (US)

(72) Inventors: Malcolm Muir Smith, Richardson, TX (US); Robert Edgar Barton, Richmond (CA); Jerome Henry, Pittsboro, NC (US)

(21) Appl. No.: 19/215,502

(22) Filed: May 22, 2025

Related U.S. Application Data
(60) Provisional application No. 63/750,888, filed on Jan. 29, 2025.

(51) Int. Cl. H04L 61/5038; H04L 61/5092; H04L 101/622; H04W 88/08

(52) U.S. Cl. CPC H04L 61/5038; H04L 61/5092; H04L 2101/622; H04W 88/08

(57) ABSTRACT

Aspects of the present disclosure are directed to enabling, in an environment in which multiple Access Points (APs) with varying privacy and Randomized and Changing MAC (RCM) configurations operate, AP-to-AP RCM in conjunction with Multi-Access Point Coordination (MAPC) between the APs without one adversely affecting the other. In one aspect, a first access point (AP) may determine a Media Access Control (MAC) rotation strategy for a first plurality of access points (APs) of a first wireless network. The MAC rotation strategy may specify use of Basic Service Set Identifiers (BSSIDs) by the first plurality of APs for implementing RCM in presence of a second plurality of APs of a second wireless network. The first AP may perform the RCM based on the MAC rotation strategy. The first AP may perform multi-AP coordination with the second plurality of APs using the BSSIDs.

### CROSS REFERENCE TO RELATED APPLICATIONS

This application claims priority to U.S. Patent Application No. 63/750,888, filed Jan. 29, 2025, entitled “802.11BI EXTENSIONS FOR WI-FI 8 MULTI-AP COORDINATION,” which is incorporated by reference herein in its entirety.

### TECHNICAL FIELD

The present technology pertains to wireless communication network, and more specifically, to implementing Access Point-to-Access Point Randomized and Changing MAC (RCM) in conjunction with Multi-Access Point Coordination in WiFi systems.

### BACKGROUND

Wi-Fi technology has undergone continuous evolution and innovation since its inception, resulting in significant advancements with each new generation. Wi-Fi 5 introduced substantial upgrades over its predecessor, Wi-Fi 4 (802.11n). It introduced the use of wider channel bandwidths, multi-user Multiple-Input Multiple-Output (MIMO), and beamforming technologies. These advancements significantly increased data transfer rates and improved network capacity, allowing multiple devices to simultaneously connect and communicate more efficiently. Wi-Fi 6 included enhanced orthogonal frequency-division multiple access (OFDMA) and target wake time (TWT) mechanisms and included greater frequency and improved overall spectral efficiency and power management and better performance in crowded areas. Wi-Fi 7 (802.11be) delivers speeds of up to 30 Gbps, utilizing multi-band operation, advanced MIMO techniques, and improved modulation schemes. Wi-Fi 7 also focuses on reducing latency and enhancing security features.

Wi-Fi 8 (802.11ce) aims to revolutionize wireless connectivity by pushing data rates to new heights, reaching up to 100 Gbps. It is expected to introduce advancements like terahertz frequencies, enhanced spatial reuse, and advanced beamforming techniques, paving the way for futuristic applications and seamless connectivity experiences.

As Wi-Fi technology continues to evolve, each new Wi-Fi generation brings improvements that address the growing demands of modern networks, including increased device density, higher data rates, lower latency, and better overall network performance. These advancements play a crucial role in enabling emerging technologies, supporting the proliferation of smart devices, and transforming the way we connect and communicate in an increasingly interconnected world.

### BRIEF DESCRIPTION OF THE DRAWINGS

To easily identify the discussion of any particular element or act, the most significant digit or digits in a reference number refer to the figure number in which that element is first introduced.

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings, and the claims.

FIG. 1 illustrates a block diagram of an example wireless communication network according to some aspects of the present disclosure.

FIG. 2A illustrates an example of a single floor of building equipped with wireless communication according to some aspects of the present disclosure.

FIG. 2B depicts an illustrative schematic diagram for MLO between an AP MLD with affiliated logical entities and a Non-AP MLD with affiliated logical entities according to some aspects of the present disclosure.

FIG. 3 illustrates an example implementation of MAC address coordination according to some aspects of the present disclosure.

FIG. 4A illustrates an example flowchart for MAC address coordination according to some aspects of the present disclosure.

FIG. 4B illustrates an example flowchart for MAC address coordination procedure where a first plurality of APs is flagged for BSSID stability according to some aspects of the present disclosure.

FIG. 4C illustrates an example flowchart for MAC address coordination procedure where a first plurality of APs rotates associated BSSIDs in relation to one or more phases of MAPC according to some aspects of the present disclosure.

FIG. 4D illustrates an example flowchart for MAC address coordination procedure where a first plurality of APs utilizes one or more sets of BSSIDs according to some aspects of the present disclosure.

FIG. 4E illustrates an example flowchart for MAC address coordination procedure where a first plurality of APs is associated with one or more algorithms of an RCM policy according to some aspects of the present disclosure.

FIG. 5 shows an example of a system for implementing certain aspects of the present technology according to some aspects of the present disclosure.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

A used herein the term “configured” shall be considered to interchangeably be used to refer to configured and configurable unless the term “configurable” is explicitly used to distinguish from “configured.” The proper understanding of the term will be apparent to persons of ordinary skill in the art in the context in which the term is used.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions, will control.

Aspects of the present disclosure can be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO) and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an internet of things (IOT) network.

### Overview

Aspects of the present disclosure are directed to enabling, in an environment in which multiple Access Points (APs) with varying privacy and RCM configurations operate, AP-to-AP RCM in conjunction with Multi-Access Point Coordination (MAPC) between the APs without one adversely affecting the other.

In one aspect, a first access point (AP) may determine a Media Access Control (MAC) rotation strategy for a first plurality of access points (APs) of a first wireless network. The MAC rotation strategy may specify use of Basic Service Set Identifiers (BSSIDs) by the first plurality of APs for implementing RCM in presence of a second plurality of APs of a second wireless network. The first AP may perform the RCM based on the MAC rotation strategy. The first AP may perform multi-AP coordination with the second plurality of APs using the BSSIDs.

In another aspect, the MAC rotation strategy may include identifying at least one AP from among the first plurality of APs that is in proximity of at least one of the second plurality of APs. Additionally, the MAC rotation strategy may include applying a stable BSSID at the first plurality of APs to implement the RCM when at least one end device is detected in association with one of the second plurality of APs.

In another aspect, the MAC rotation strategy may include identifying at least one AP from among the first plurality of APs that is in proximity of at least one of the second plurality of APs. The MAC rotation strategy may further include applying a stable BSSID at the first plurality of APs to implement the RCM.

In another aspect, the MAC rotation strategy may include rotating the BSSIDs in relation to one or more phases of the multi-AP coordination between the first plurality of APs and the second plurality of APs, the one or more phases including a discovery phase, a configuration phase, and an operation phase.

In another aspect, the MAC rotation strategy may include applying a first set of BSSIDs for the multi-AP coordination, wherein the first set of BSSIDs is the same for all APs of the first plurality of APs. The MAC rotation strategy may include applying a second set of BSSIDs that is different from the first set of BSSIDs for the RCM operation.

In another aspect, the MAC rotation strategy may include exchanging, between the first plurality of APs and the second plurality of APs, corresponding RCM policies prior to the multi-AP coordination, each of the corresponding RCM policies including a corresponding rotation schedule and corresponding keys for utilizing BSSIDs. The MAC rotation strategy may further include performing the RCM operation and the multi-AP coordination based on the corresponding rotation schedule.

In another aspect, the MAC rotation strategy may include preventing changes to the BSSIDs for a duration of time around a scheduled operation for the multi-AP coordination, based on the corresponding rotation schedule. Or, in some other aspects, the MAC rotation strategy may include adjusting the scheduled operation to prevent rotation of the BSSIDs, based on the corresponding rotation schedule. Other technical features may be readily apparent to one skilled in the art from the following figures, descriptions, and claims.

In one aspect, an access point comprising one or more processors and a memory storing instructions that, when executed by the one or more processors, configure the access point to determine a Media Access Control (MAC) rotation strategy for a first plurality of access points (APs) of a first wireless network. The MAC rotation strategy may specify use of Basic Service Set Identifiers (BSSIDs) by the first plurality of APs for implementing RCM in presence of a second plurality of APs of a second wireless network. The access point may be further configured to perform the RCM based on the MAC rotation strategy. The access point may be further configured to perform multi-AP coordination with the second plurality of APs using the BSSIDs.

In one aspect, one or more non-transitory computer-readable media comprising computer-readable instructions, which when executed by one or more processors of an access point, cause the access point to determine a Media Access Control (MAC) rotation strategy for a first plurality of access points (APs) of a first wireless network. The MAC rotation strategy may specify use of Basic Service Set Identifiers (BSSIDs) by the first plurality of APs for implementing RCM in presence of a second plurality of APs of a second wireless network. The access point may be further configured to perform the RCM based on the MAC rotation strategy. The access point may be further configured to perform multi-AP coordination with the second plurality of APs using the BSSIDs.

### Example Embodiments

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The disclosed technology addresses the need in the art for enabling independent MAC rotation processes on distinct WLAN domains (e.g., an enterprise domain and a public domain). The WiFi Alliance's (WFA) 802.11bi defines a Block Phase Encryption (BPE) mode, where the Access Point (AP) identifiers are obfuscated from observers'view. The AP rotates its Media Access Control (MAC) address (i.e., Basic Service Set Identifier (BSSID)) at intervals, and only the associated Stations (STAs) know which MAC address is next in the sequence. In some examples, APs associated with distinct WLAN domains may include MAPC, which involves the use of standardized mechanisms (e.g., Coordinated OFDMA, Coordinated Beamforming, and/or Joint Transmission) to synchronize communication among APs associated with distinct WLAN domains. MAPC enables APs to share scheduling, CSI (Channel State Information), and transmission timing to reduce contention and optimize simultaneous data delivery. Unlike the Wi-Fi single Basic Service Set (BSS) case, the MAPC case adds the complexity of coordination between distinct WLAN domains that may include foreign APs with different privacy objectives and RCM configuration. In other words, MAPC introduces the complexity of AP-to-AP coordination between neighboring APs which may not belong to the same WLAN domain and have different privacy objectives and privacy configurations. The question not currency addressed in the 802.11bi specification is, how to implement AP-to-AP RCM without adversely affecting multi-AP coordination?

The present disclosure, through various example embodiments described below, offer several solutions to address the shortcomings of the current 802.11bi specification and enable AP-to-AP RCM in conjunction with MAPC. The proposed solutions include, but are not limited to, use of stable Basic Service Set Identifiers (BSSIDs) with minimal or no MAC address rotations, MAC address rotation in coordination with MAPC operations, use of separate BSSID pools for RCM and MAPC operations, and advance exchange of RCM policies between local and foreign APs. Each of these examples will be described in more detail below.

For example, in a first implementation, select APs on a network do not rotate MAC addresses. BSSs are separated based on their possible relationships with external/foreign BSSs. APs that are in the neighborhood of foreign APs (APs not in the control of the local system such as the enterprise network, the public network, etc.) apply a stable BSSID (i.e., no BPE AP MAC rotation) or a stable BSSID when STAs are detected on the neighboring foreign APs.

In a second implementation, APs associated with the network may include scheduled periods where MAC address rotation stops (e.g., during MAPC discovery, configuration, and operation phases. The local AP BSSID rotates in accordance with the MAPC operations, but a stable BSSID value is maintained during the MAPC discovery, configuration, and operation phases (where APs learn each other's service periods/SPs and schedule accordingly).

In a third implementation, APs associated with the network may rotate through a pool of MAC addresses. A separate BSSID pool is used for inter-BSS/MAPC operations and specifically for foreign APs operations, where the local AP BSSID takes different values in a stable pool, but the pool is the same for all APs of the local system that are in contact with foreign APs. Thus, an observer can see a stable BSSID, but the location of the BSSID keeps changing as different APs use the value in turn.

In a fourth implementation, APs associated with the network may be associated with an individual algorithm used to determine the MAC address rotation scheme. The local and the foreign WLAN exchange epoch (rotation schedule) and keys in advance of MAPC operation, allowing each to know when the other is rotating its BSSIDs, and what the next BSSID value will be.

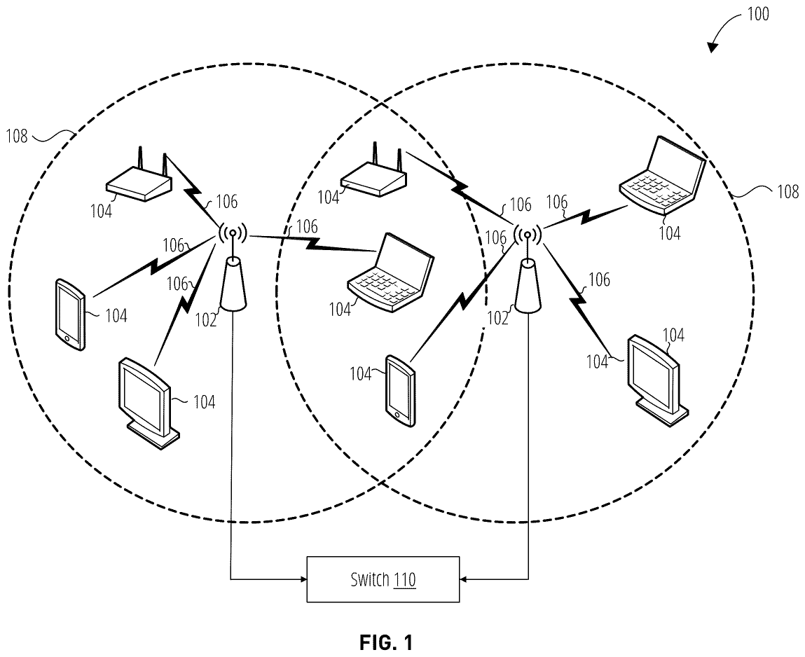

FIG. 1 illustrates a block diagram of an example wireless communication network according to some aspects of the present disclosure. According to some aspects, the wireless communication network 100 may be an example of a wireless local area network (WLAN) such as a Wi-Fi network. For example, the wireless communication network 100 may be a network implementing at least one of the IEEE 802.11 family of wireless communication protocol standards and amendments thereof (such as that defined by the IEEE 802.11-2016 specification or amendments thereof including, but not limited to, 802.11ay, 802.11ax, 802.11az, 802.11ba and 802.11be). Additionally, the wireless communication network 100 may implement future versions and amendments of the wireless communication protocol standards and amendments thereof such as 802.11bn and be modified according to the present disclosure to include the features contained herein. The wireless communication network 100 may include numerous wireless communication devices such as an AP actor, which can be one or more of a non-MLD AP, an AP affiliated with an AP MLD, and/or an AP MLD. In the examples presented herein, the AP actor can exclude an upper UMAC. Therefore, the AP actor can include the lower UMAC, LMAC, and/or PHY. Additionally, the WLAN can include one or more of STA actors 104, which can be one or more of a non-MLD STA, a STA affiliated with a non-AP MLD, and/or a non-AP MLD. As illustrated, the wireless communication network 100 also may include multiple AP actors such as AP actors 102 (may also be referred to as simply AP). The AP actors 102 can be coupled to one another through a switch 110. While the AP actors 102 are shown as being coupled to one another through a switch 110, the network can provide another device that allows the coupling of the multiple AP actors.

Each of the STA actors 104 also may be referred to as a mobile station (MS), a mobile device, a mobile handset, a wireless handset, an access terminal (AT), a user equipment (UE), a subscriber station (SS), client, or a subscriber unit, among other examples. The STA actors 104 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other examples. In other examples, the STA actors 104 can be referred to as clients and/or client devices.

Any one of the AP actors 102 and an associated set of STA actors (e.g., STA actors 104) may be referred to as a basic service set (BSS), which is managed by a respective AP actor of AP actors 102. FIG. 1 additionally shows example coverage areas 108 of each of the AP actors 102, which may represent a basic service area (BSA) of the wireless communication network 100. As illustrated, three of the STA actors 104 are within the BSA of each of the AP actors 102. The BSS may be identified to users by a service set identifier (SSID), where the BSS might be one of many in the SSID. The BSS may be identified to other devices by a unique (or substantially unique) basic service set identifier (BSSID). One or more of the AP actors 102 periodically broadcasts beacon frames (“beacons”) including the BSSID to enable STA actors 104 within wireless range of the AP actors 102 to “associate” or re-associate with the AP actors 102 to establish a respective communication link of communication links 106 (hereinafter also referred to as a “Wi-Fi link”), or to maintain the communication links 106, with the AP actors 102. For example, the beacons may include an identification of a primary channel used by the respective AP actor of AP actors 102 as well as a timing synchronization function for establishing or maintaining timing synchronization with the AP actors 102. The AP actors 102 may provide communication links 106 to the STA actors 104 and therefore access to external networks. While the example has been described in regard to the AP actors 102 and STA actors 104, the present disclosure extends such that an AP actor may provide access to external networks to various STA actors in a WLAN via the communication links 106.

To establish the communication links 106 with any one of the AP actors 102, each of the STA actors 104 is configured to perform passive or active scanning operations (“scans”) on frequency channels in one or more frequency bands (for example, the 2.4 GHz, 5 GHz, 6 GHz, or 60 GHz bands). To perform passive scanning, the STA actors 104 listen for beacons, which are transmitted by a respective AP actor of AP actors 102 at or near a periodic time referred to as the target beacon transmission time (TBTT) (measured in time units (TUs) where one TU may be equal to 1024 microseconds (μs)). To perform active scanning, the STA actors 104 generate and sequentially transmit probe requests on each channel to be scanned and listens for probe responses from AP actors 102. The STA actors 104 may be configured to identify or select an AP and thence a selected AP actor of AP actors 102 with which to associate based on the scanning information obtained through the passive or active scans, and to perform authentication and association operations to establish the communication links 106 with the selected AP actor of AP actors 102. The selected AP actor of AP actors 102 assigns an association identifier (AID) to the STA actors 104 at the culmination of the association operations, which the selected AP actor of AP actors 102 uses to improve the efficiency of certain signaling to the STA actors 104.

The present disclosure modified the WLAN radio and baseband protocols for the PHY and medium access controller (MAC) layers. The AP actors 102 and STA actors 104 transmit and receive wireless communications (hereinafter also referred to as “Wi-Fi communications”) to and from one another in the form of PHY protocol data units (PPDUs). The AP actors 102 and STA actors 104 also may be configured to communicate over other frequency bands such as shared licensed frequency bands, where multiple operators may have a license to operate in the same or overlapping frequency band or bands.

Each PPDU is a composite structure that includes a PHY preamble and a payload in the form of one or more PHY service data unit (PSDU). The information provided in the preamble may be used by a receiving device to decode the subsequent data in an intended PSDU. In instances in which PPDUs are transmitted over a bonded channel, selected preamble fields may be duplicated and transmitted in each of the multiple component channels.

In some iterations of Wi-Fi, such as Wi-Fi 8, IEEE 802.11bn may define a Media Access Control (MAC) address rotation implementation for Wi-Fi networks. MAC address rotation is a security mechanism designed to enhance privacy in wireless networks by periodically changing the MAC address of a device (e.g., AP actors 102, STA actors 104, etc.). This process involves dynamically altering the unique identifier assigned to a network interface, making it difficult for external entities to track or profile devices based on their MAC addresses. Individual networks may have individual RCM policies that dictate how MAC addresses are rotated at devices throughout the network. The rotation is typically implemented at the software level, where the network interface card (NIC) is programmed to generate and assign new MAC addresses at regular intervals or upon specific triggers, such as connecting to a new network. This approach mitigates the risk of unauthorized tracking and profiling by obfuscating the device's identity, thereby enhancing user privacy and security.

The implementation of MAC address rotation poses challenges in maintaining seamless communication and network interoperability. As devices frequently change their MAC addresses, traditional network protocols that rely on static identifiers for routing and access control may experience disruptions. This necessitates the development of advanced coordination mechanisms to ensure that devices can still authenticate and communicate effectively within the network. Additionally, network policies and access control lists must be adapted to accommodate dynamic MAC addresses, requiring more sophisticated algorithms to manage device identification and authorization.

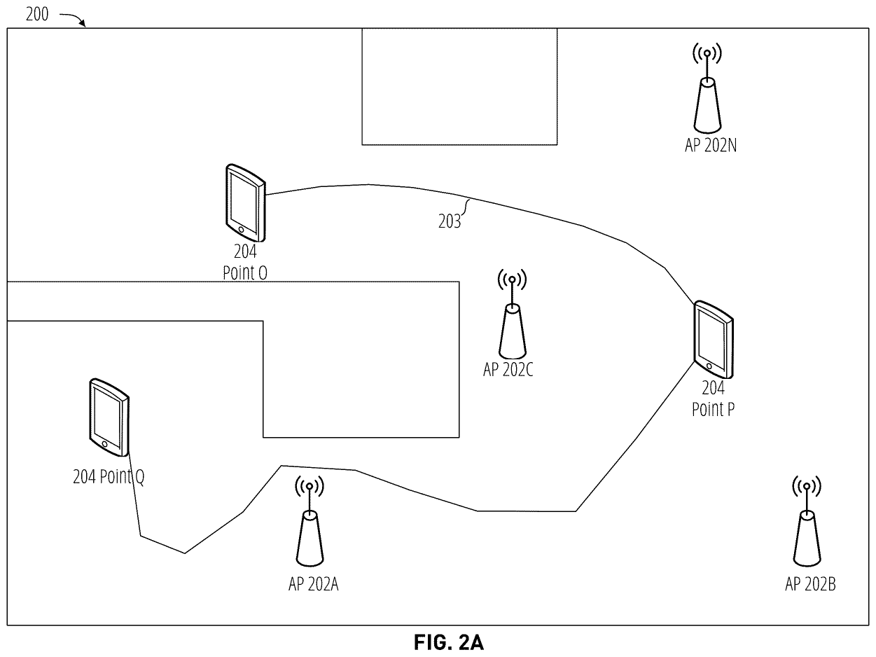

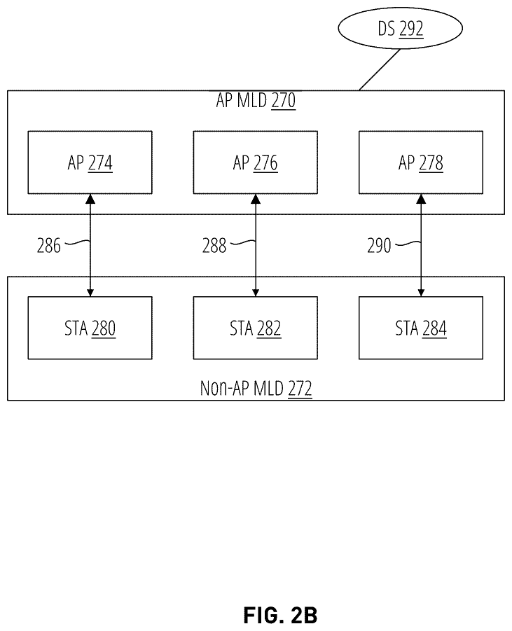

FIG. 2A illustrates an example of a single floor of building equipped with wireless communication according to some aspects of the present disclosure. While only a single floor is illustrated, a description equally applies to multiple floors in a building. Additionally, some of the floors in a building may not be contiguous, such that floors 1, 3, 4, and 8 span a network for a building that has floors 1-10. Thus, in at least one implementation the building can include one or more floors that do not have a network including one or more AP actors. As illustrated, the single floor 200 includes AP actors 202A, 202B, 202C, 202C, 202N. Each of the AP actors 202A, 202B, 202C, 202N can have a respective coverage area such that an overall coverage area can span substantially the entire floor. In other examples, the overall coverage area can extend beyond the entire floor. In other examples, the overall coverage area can extend beyond the entire floor. Additionally, the coverage of an AP actor of AP actors 202A, 202B, 202C, 202N may substantially overlap with the coverage of another AP actor of the AP actors 202A, 202B, 202C, 202N.

As illustrated by the line 203, STA actor 204 can move from point O to point P to point Q. In some examples, STA actor 204 may be configured as an AP associated with the network. When a STA actor 204 is moving around on a given floor, one or more of the AP actors 202A, 202B, 202C, 202N can be considered to be nearest to the STA actor 204. Nearest as used in relation to the AP actors 202A, 202B, 202C, 202N and STA actor 204 can include being physically nearest (for example, a Euclidean distance on the floor) and/or pathloss-nearest (for example, having the lowest wireless attenuation (pathloss) between AP actor, among all the AP actors, and STA actor). Additionally, the pathloss-nearest approach can be used to reduce the likelihood of connection between an AP actor on a floor above or below the STA actor 204. The location of the AP actor on the floor above or below might be closer in a Euclidean sense, but also not be a desirable AP for the connection of the device or station due to the floor location and/or possible signal interruption. The location of the AP actor on the floor above or below might be closer in a straight line and/or Euclidean sense, but also not be a desirable AP for the connection of the device or station due to the floor location and/or possible signal interruption. Additionally, the coverage of one or more AP actors can at least partially overlap with the coverage of one or more other AP actors. The present disclosure provides for selecting the AP actor and/or providing a communication pathway from one or more STA actors through one or more AP actors.

FIG. 2B depicts an illustrative schematic diagram for MLO between an AP MLD with affiliated logical entities and a Non-AP MLD with affiliated logical entities according to some aspects of the present disclosure.

Referring to FIG. 2B, two multi-link logical entities AP MLD 270 and Non-AP MLD 272 are shown. AP MLD 270 may include physical and/or logically affiliated AP such as AP 274, AP 276, and AP 278 operating in different channels and typically different frequency bands (e.g., 2.4 GHz, 5 GHz, and 6 GHz). AP 274, AP 276, and AP 278 may be the same as or similar to any one of the APs described above (e.g., AP actors 102). Non-AP MLD 272 may include STA 280, STA 282, and STA 284, which may be the same as or similar to any of the STAs as described herein. In some examples, STA 280, STA 282, and STA 284 may be configured to function as APs, similarly to AP 274, AP 276, and AP 278.

AP 274 may communicate with STA 280 via link 286. AP 276 may communicate with STA 282 via link 288. AP 278 may communicate with STA 284 via link 290.

AP MLD 270 is shown in FIG. 2B to have access to a distribution system (DS) such as DS 292, which is a system used to interconnect a set of BSSs to create an extended service set (ESS).

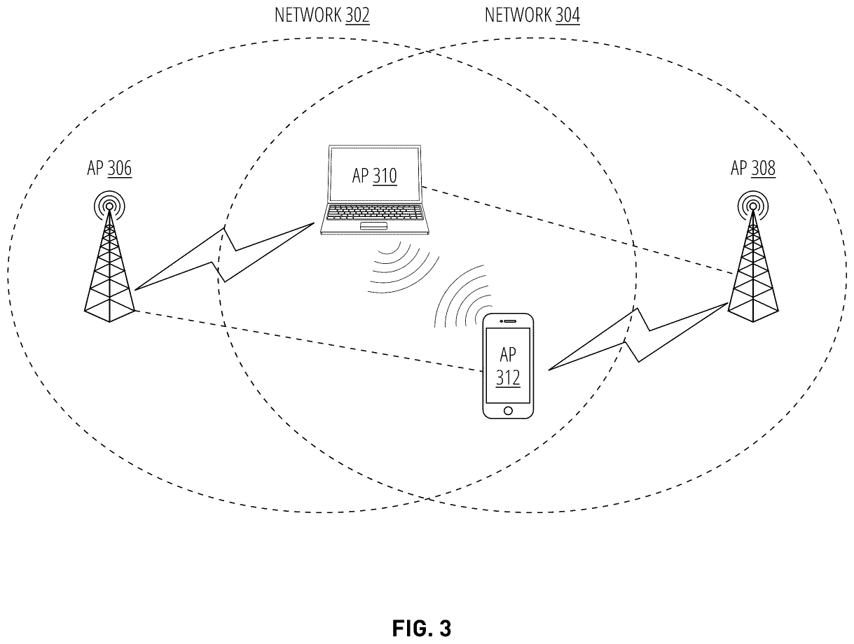

It should be understood that although the example shows three logical entities within the AP MLD and the three logical entities within the Non-AP MLD, this is merely for illustration purposes and that other numbers of logical entities within each of the AP MLD and Non-AP MLD may be envisioned. The example Wi-Fi systems and MLO described above with reference to FIG. 1, FIG. 2A, and FIG. 2B provide examples of simplified and example systems of the present disclosure. Additional details of the present disclosure are provided in relation to FIGS. 3, 4, and 5.

FIG. 3 illustrates an example implementation of MAC address coordination according to some aspects of the present disclosure. The technology disclosed herein focuses on advancements in Wi-Fi 8, specifically enhancing MAPC and addressing privacy concerns. The primary challenge is maintaining user privacy while ensuring effective coordination between multiple access points (APs) in a Wi-Fi network. This involves managing MAC address rotations to prevent unauthorized tracking and enabling APs to communicate and coordinate without revealing their identities. The present disclosure provides solutions for these challenges, particularly in environments with numerous APs, such as airports or shopping malls, where privacy and coordination are essential.

The proposed solutions include several embodiments. One approach involves certain APs maintaining a stable MAC address to facilitate coordination, especially in public environments where privacy concerns are less critical. Another embodiment involves temporarily stabilizing MAC addresses during coordination phases, allowing APs to negotiate and schedule operations effectively. This method ensures uninterrupted communication during critical operations, such as voice calls, by freezing MAC address changes during discovery and negotiation phases. Additionally, the technology disclosed herein suggests using a pool of MAC addresses that rotate predictably, allowing APs to anticipate each other's MAC address changes, thus maintaining coordination without compromising privacy. The present disclosure also explores algorithms to predict MAC address changes, enabling APs to compute each other's future MAC addresses based on shared algorithms. This approach allows for dynamic MAC address changes while maintaining predictability for coordination purposes. The invention aims to balance the need for privacy with the operational requirements of multi-AP coordination, ensuring efficient Wi-Fi network functionality in complex environments. These innovations are significant in the context of evolving Wi-Fi standards and address potential conflicts between privacy and coordination requirements.

As an illustrative example, network 302 and network 304 may be two Wi-Fi networks configured with Wi-Fi 8 capabilities. Network 302 and network 304 may be associated with respective stations (STAs), access points (APs), and/or other devices associated with a wireless network. For example, network 302 may be associated with AP 306 and AP 310. Network 304 may be associated with AP 308 and AP 312. In some examples, AP 306 and/or AP 310 may be similar to AP actors 102 (as described in FIG. 1). For example, AP 306 and/or AP 310 may include some or all of the capabilities of AP actors 102. In some examples, AP 308 and/or AP 312 may be similar to STA actors 104 (as described in FIG. 1). For example, AP 308 and/or AP 312 may include some or all of the capabilities of STA actors 104. As used herein in reference to FIG. 3, an AP may serve as a communication hub to a respective network, facilitating Internet access and coordination among multiple APs on the network. An AP (e.g., AP 306, AP 308, AP 310, and AP 312) can be, for example, a smartphone, a laptop, a smartwatch, a tablet, a router, any combination thereof, or the like. As illustrated in FIG. 3, AP 310 may be, for example, a laptop computer, and AP 312 may be, for example, a smartphone. The APs associated with respective networks (e.g., network 302 and network 304) manage MAC address rotations to prevent unauthorized tracking.

APs associated with different networks (e.g., AP 310 associated with network 302 and AP 312 associated with network 304) interact through coordination protocols that enable seamless communication and data exchange, such as MAPC. The MAPC process may begin with APs (e.g., AP 310 and AP 312) exchanging capabilities and synchronization information over a backhaul link or through over-the-air signaling. The APs then may share real-time data such as Channel State Information (CSI), scheduling intent, and client association status. Based on this, the APs negotiate or infer coordination strategies (e.g., aligning transmission schedules, selecting RU (Resource Unit) allocations, configuring beamforming vectors, etc.) using a common time reference. Coordination updates are exchanged periodically or upon trigger events (e.g., client movement), allowing the APs to dynamically adjust resource usage and maintain alignment. For example, AP 310 and AP 312 may utilize beacon frames and probe requests to communicate with each other. In addition to the communications between AP 310 and AP 312, cross-network communication may also occur between devices on distinct networks. For example, AP 306 may coordinate with AP 312 to passively detect and/or monitor AP 312 through probe requests, signal measurements, and/or frame observation. This may support functions including, but not limited to, interference avoidance, roaming preparation, and coordinated scheduling. AP 308 may coordinate with AP 310 to perform similar functionality.

In some examples, security concerns may arise related to the communication between AP 310 and AP 312 (e.g., managing interference, ensuring secure data transmission, etc.). MAC address (i.e., BSSID) rotation enhances the security of these communications by periodically changing the unique identifier of a device (e.g., AP 306, AP 308, AP 310, and AP 312), making it difficult for unauthorized entities to track or profile devices based on a respective MAC address. In communications between APs on different networks (e.g., AP 310 and AP 312), MAC rotation helps prevent eavesdropping and tracking by obscuring the identity of the devices involved. However, in practice, the implementation of MAC address rotation complicates communication between AP 310 and AP 312 because it disrupts the ability to consistently identify and authenticate devices. The RCM policies (e.g., MAC address rotation scheme) may vary from network 302 to network 304. In some examples, the RCM policies may include no MAC address rotation. Because of varying RCM policies between networks, the rotation may be unpredictable, and when a device (e.g., AP 310 and/or AP 312) frequently changes its MAC address/BSSID, other devices (e.g., AP 310 and/or AP 312) and networks may struggle to recognize it as the same entity, leading to challenges in maintaining stable connections and sessions. This can interfere with network protocols that rely on static MAC addresses for routing and access control, causing disruptions in communication between AP 310 and AP 312. Additionally, security measures like access control lists and network policies may not function effectively if they cannot reliably identify devices, leading to potential connectivity issues and increased complexity in managing network interactions.

To adapt MAC address rotation to accommodate communications between AP 310 and AP 312 (e.g., APs associated with different WLAN networks), one or more embodiments may be implemented on a network (e.g., a WLAN network, such as network 302 and network 304) to allow MAC address of some or all APs associated with the network to be stable and/or predictable during important events, such as a coordination event. The one or more embodiments may be implemented on a network-by-network basis, where network 302 may implement a first embodiment while network 304 may implement a second embodiment. In some examples, the one or more embodiments may be implemented according to hardware (e.g., a first hardware manufacturer may configure hardware to implement a first embodiment, while a second hardware manufacturer may configure hardware to implement a second embodiment). The one or more embodiments may be selected (e.g., by an AP, by a central controller, by an administrator of the network, etc.) according to a selection criteria, hardware restraints, network size, network needs, network bandwidth, cost, compatibility, network priorities (e.g., security, reliability, scale, etc.), any combination thereof, or the like. Further, in some examples, a network (e.g., a WLAN network, such as network 302 and network 304) may include one or more leader APs. The leader APs may be associated with respective coordination groups, which may be comprised of one or more APs of the network. The coordination groups may apply different embodiments (e.g., a first coordination group may implement a first embodiment, while a second coordination group may implement a second embodiment), depending on the requirements of the network. The applicable embodiment may be communicated to the coordination group by the respective leader AP, which may receive instructions from a manager of the network (e.g., a central controller, a MAC rotation manager component, an administrator of the network, any combination thereof, or the like).

The first embodiment involves having some APs (e.g., APs that are in the neighborhood of foreign APs) flagged for stability on the network. In some examples, the flagged APs may be identified by a manager of the network (e.g., a central controller, a MAC rotation manager component, a leader AP, an administrator of the network, any combination thereof, or the like). These flagged APs may not change an associated MAC address (i.e., BSSID), which is useful for signaling stability in environments with multiple APs. The remaining APs associated with the network may implement a different embodiment than stability, or may continue with the MAC rotation policy dictated by the network. In some examples, the stable MAC address may be constant, or may be implemented in response to detection of a foreign AP. For example, AP 310 may maintain a stable MAC address/BSSID while AP 312 is in the local vicinity of AP 310, and AP 312 may maintain a stable MAC address/BSSID while AP 310 is in the local vicinity of AP 312. In some other examples, AP 310 and/or AP 312 may maintain a stable MAC address/BSSID for a duration of time (e.g., indefinitely, one hour, one minute, 24 hours, etc.) designated by network 302. In some examples, MAC address stability may be indicated by a flag associated with a stable AP (e.g., AP 310 and/or AP 312).

This first embodiment is particularly beneficial in public areas like airports, where the visibility of MAC addresses is often not a concern because the Wi-Fi is public, and there is less emphasis on engaging with individual users through specific apps. Airports typically prioritize stable connectivity over privacy concerns related to MAC address tracking. In contrast, shopping malls may want to keep their MAC addresses private to prevent crowdsourcing companies from mapping their locations. For example, malls often aim to engage directly with customers through their own apps, offering navigation and promotions. If a crowdsourcing service (e.g., Google Maps or Apple Maps) provides detailed maps of the mall, it can undermine the mall's efforts to interact with customers through their app. Therefore, malls may prefer to hide or rotate MAC addresses to maintain control over customer engagement and location data. The embodiment allows for selective application, where only certain APs, such as those on the network's edge, maintain a stable MAC address to facilitate coordination with neighboring networks.

The second embodiment proposes stabilizing the MAC address (i.e., BSSID) of an AP (e.g., AP 310 and/or AP 312) during the duration of a necessary exchange or coordination event. For example, a MAC address associated with AP 310 and a MAC address associated with AP 312 may be stabilized when AP 310 and/or AP 312 need to communicate for tasks, including, but not limited to, scheduling. The MAC address may become stable when AP 310 and AP 312 begin negotiating, ensuring that they can reliably identify each other. This stability may last until the negotiation is complete, allowing AP 310 and AP 312 to coordinate effectively without interruptions.

The trigger for stabilizing the MAC address may occur during the discovery phase. Initially, AP 310 and AP 312 may rotate respective MAC addresses according to the RCM policies of associated networks (e.g., AP 310 and network 302, AP 312 and network 304), but when AP 310 and AP 312 require coordination, a mechanism is activated. In some examples, this involves one AP (e.g., AP 310) sending a message to another (e.g., AP 312), indicating the need to schedule. During this phase, the MAC addresses of AP 310 and/or AP 312 are frozen, allowing for seamless negotiation and setup between AP 310 and AP 312. Once communications are established, such as for protecting a voice call, the MAC addresses of AP 310 and AP 312 can resume their rotation based on the RCM policies of associated networks (e.g., network 302 and/or network 304).

In the third embodiment, APs rotate through a predefined pool of MAC addresses (i.e., BSSIDs), allowing for predictable changes that can be anticipated by other APs. For example, a pool might contain 100 MAC addresses, and each AP follows a specific sequence. This allows APs to predict a next MAC address of neighboring APs, facilitating seamless communication. A wireless LAN controller associated with a network may ensure that each AP on a network floor has a unique MAC address at any given time, preventing duplicates. This method confuses eavesdroppers, as the same MAC addresses appear to move between different APs, thwarting crowdsourcing efforts to map the network.

In some examples, there may be more than one pool of MAC addresses associated with the network. For example, a first stable BSSID pool may be utilized by one or more flagged APs that may be in the neighborhood of foreign APs. The flagged APs may be identified by a manager of the network (e.g., a central controller, a MAC rotation manager component, a leader AP, an administrator of the network, any combination thereof, or the like). The one or more flagged APs may periodically rotate through the first stable BSSID pool (e.g., sequentially utilize BSSIDs associated with the first stable BSSID pool) according to a rotation schedule associated with the network (e.g., also managed by a manager of the network). In some examples, the rotation schedule associated with the first stable BSSID pool may be utilized in combination with a period of stability during MAPC operations (e.g., as mentioned above, such as during the duration of a necessary exchange or coordination event). The other APs that are not identified as one or more flagged APs (e.g., a second group of APs) may utilize a second BSSID pool. The second group of APs may periodically rotate through the second BSSID pool according to a rotation schedule associated with the network. The rotation schedule associated with the one or more flagged APs and the rotation schedule associated with the second group of APs may be the same. However, in some examples, the respective rotation schedules may differ. In some other examples, the second group of APs may utilize a different rotation strategy altogether and may not incorporate the second pool of BSSIDs.

For example, AP 310 may rotate through a predefined pool of MAC addresses associated with network 302 and/or an associated coordination group and AP 312 may rotate through a predefined pool of MAC addresses associated with network 304 and/or an associated coordination group. AP 310 may transmit the respective predefined pool (in sequence) associated with AP 310 to AP 312 so that AP 312 can predict the next MAC address of AP 310. In a similar fashion, AP 312 may transmit the respective predefined pool (in sequence) associated with AP 312 so that AP 310 can predict the next MAC address of AP 312. In some examples, the manager of the network (e.g., a central controller, a MAC rotation manager component, an administrator of the network, any combination thereof, or the like) may monitor a pool size associated with the network to ensure that the pool size is larger than the number of APs to ensure sufficient entropy and effective obfuscation. The third embodiment may be beneficial in scenarios where there are few APs that operate under a remote controller (e.g., a gas station, a residence, a small business, etc.).

The fourth embodiment involves each access point changing its MAC address (i.e., BSSIDs) at pseudo-random intervals, using an algorithm that can be shared among access points to predict future MAC addresses. In some examples, the algorithm is consistent across APs of a network, but the base (i.e., seed) MAC address and change timing may vary, creating an appearance of randomness. This algorithm considers factors like the current MAC address or time, allowing APs to predict each other's next MAC address. In some examples, networks (e.g., network 302 and network 304) and/or the APs (e.g., AP 310 and AP 312) exchange RCM policies before the MAPC operation begins. For example, the RCM policy may include a corresponding rotation schedule and corresponding keys (e.g., algorithms) for utilizing BSSIDs. This method allows for individual MAC address changes while maintaining predictability for coordination purposes. APs can exchange their algorithms and/or directly inform each other of upcoming MAC addresses, ensuring predictable changes for effective coordination. In some examples, AP 310 may transmit an associated algorithm to AP 312, and AP 312 may transmit an associated algorithm to AP 310. In some examples, the RCM policies associated with the APs may also prevent changes to the BSSIDs for a duration of time according to the corresponding rotation schedule. In some examples, the APs may adjust the BSSIDs according to the corresponding RCM policies based on the corresponding rotation schedule. Unlike using a static pool of MAC addresses, this method involves individual changes at the AP level, creating an appearance of randomness while maintaining predictability for other APs. In some examples, this fourth embodiment implementation may be beneficial when applied to large scale applications, where managing a pool large enough to facilitate the third embodiment may be impracticable.

A variation of the fourth embodiment involves using mutual epoch knowledge to delay MAC address (i.e., BSSID) changes during specific scheduled MAPC operations, such as certain Coordinated Real-Time Wireless Transmission (C-R-TWT) service periods, to prevent ambiguity. This approach also allows for adjusting the MAPC scheduled operation service period time to avoid a rotation, improving upon the first embodiment by permitting BSSID rotation during the MAPC operation phase.

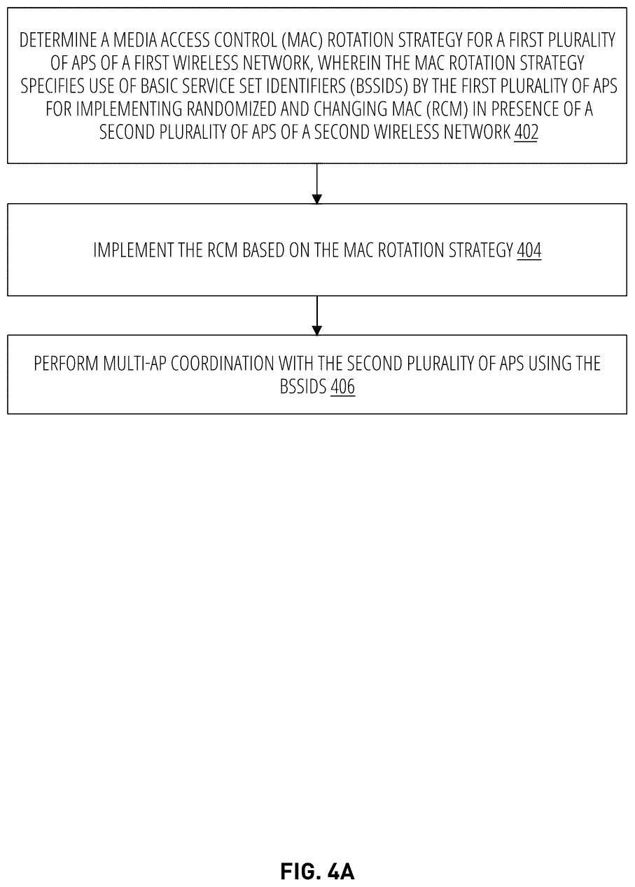

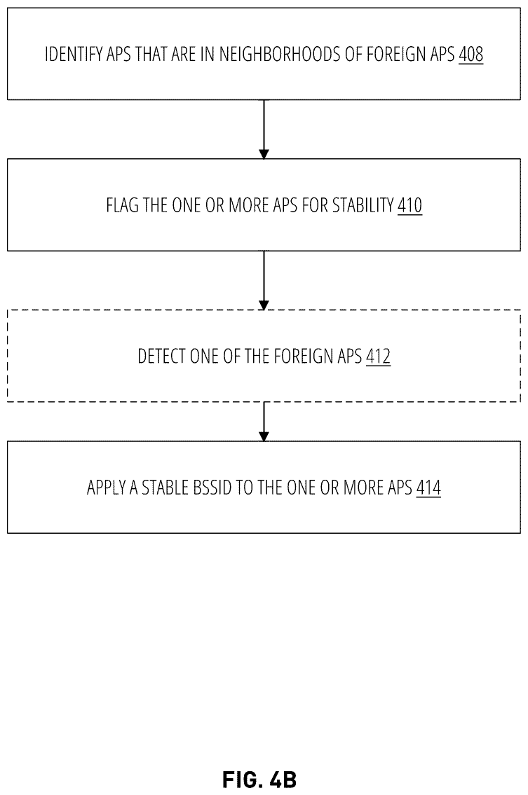

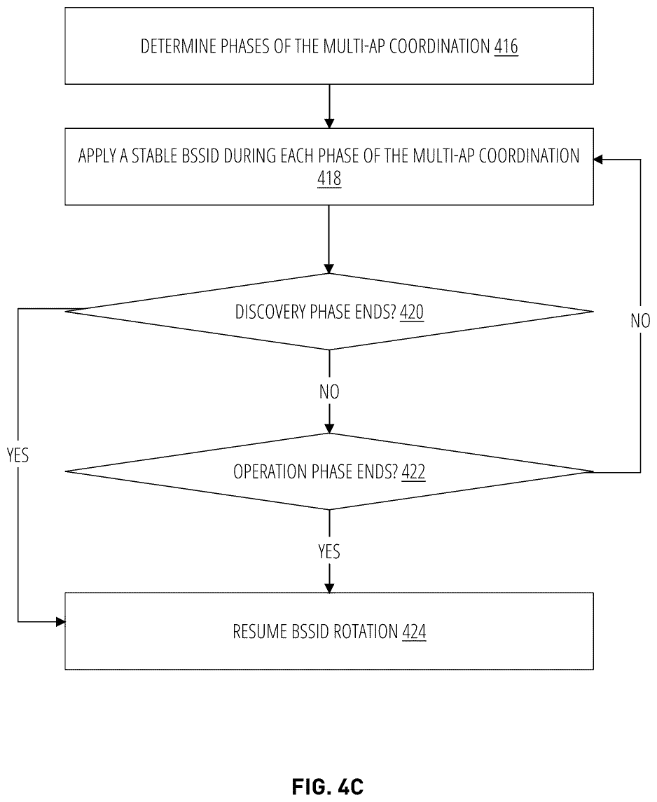

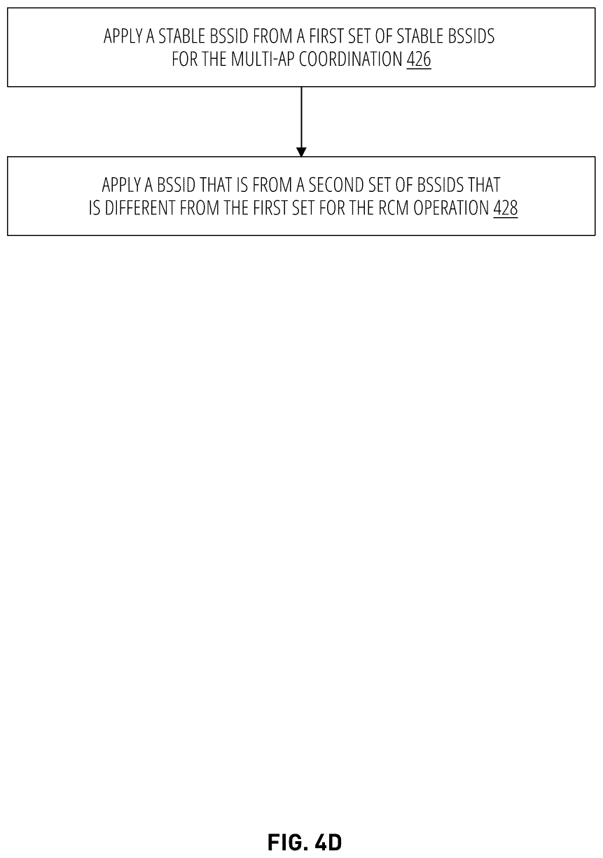

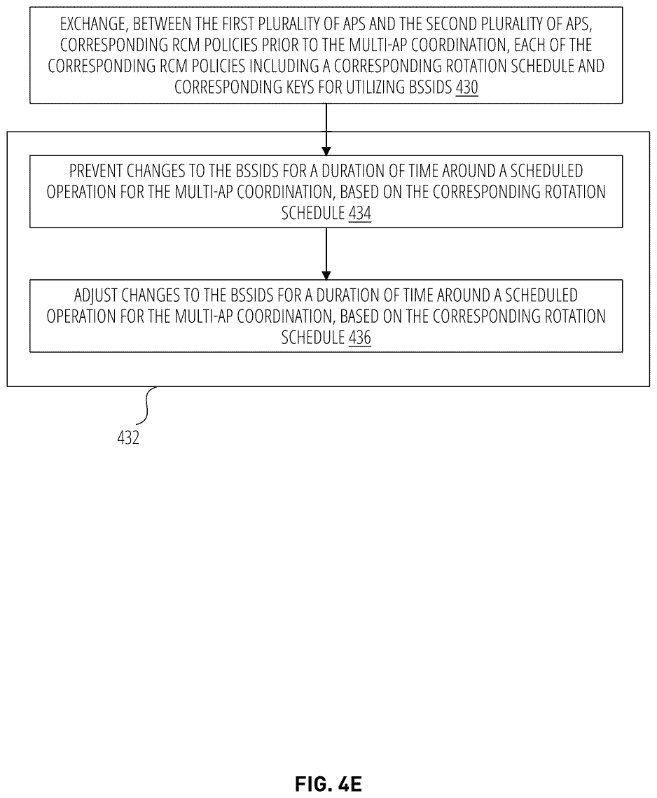

FIGS. 4A-4E illustrate example flowcharts for certain aspects of MAC address coordination according to some aspects of the present disclosure. Although the example flowcharts depict particular sequences of operations, the sequences may be altered without departing from the scope of the present disclosure. For example, some of the operations depicted may be performed in parallel or in a different sequence that does not materially affect the function of the components that may perform any of the methods described in FIGS. 4A-4E (e.g., AP actors 102, STA actors 104, AP actors 202A-N, STA actor 204, AP 306, AP 310, AP 312, AP 308, any combination thereof, or the like, as described herein at FIGS. 1-3). In other examples, different components of an example device or system that implements the methods described in the foregoing flowcharts may perform functions at substantially the same time or in a specific sequence.

FIG. 4A illustrates an example flowchart for MAC address coordination according to some aspects of the present disclosure.

In block 402, a first plurality of APs may determine a selection for a Media Access Control (MAC) rotation strategy for the first plurality of APs of a first wireless network, wherein the MAC rotation strategy specifies use of Basic Service Set Identifiers (BSSIDs) by the first plurality of APs for implementing RCM in presence of a second plurality of APs of a second wireless network. The selection may be based on the needs of the first wireless network, including, but not limited to, size of the first wireless network (e.g., number of devices), security needs, hardware capabilities, application (e.g., environment), etc. For example, a central controller (e.g., instructed by an administrator, instructed by settings associated with the first wireless network, etc.) associated with AP 310 (as described in FIG. 3) may select a MAC rotation strategy for AP 310 on network 302, where the MAC rotation strategy specifies use of BSSIDs by AP 310 for implementing RCM mechanisms in presence of AP 312 and AP 308 (as described in FIG. 3) associated with network 304 (as described in FIG. 3) that is distinct from network 302.

In block 404, the first plurality of APs may implement the RCM based on the MAC rotation strategy. For example, AP 310 may utilize BSSIDs to implement the RCM based on the MAC rotation strategy in the presence of AP 312.

In block 406, the first plurality of APs may perform multi-AP coordination with at least one of the second plurality of APs using the BSSIDs. For example, AP 310 may perform multi-AP coordination with AP 312 using the BSSIDs. In some examples, the BSSIDs may be a stable BSSID implemented at the first plurality of APs, based on the determination at block 404.

FIG. 4B illustrates an example flowchart for MAC address coordination procedure where a first plurality of APs is flagged for BSSID stability according to some aspects of the present disclosure. For example, select APs on a network do not rotate MAC addresses. BSSs are separated based on their possible relationships with external/foreign BSSs. APs that are in the neighborhood of foreign APs (APs not in the control of the local system such as the enterprise network, the public network, etc.) apply a stable BSSID (i.e., no BPE AP MAC rotation) or a stable BSSID when STAs (e.g., other APs, edge devices, etc.) are detected on the neighboring foreign APs.

In block 408, a MAC rotation strategy may include identifying APs that are in the neighborhood of foreign APs. For example, a manager of the network (e.g., a central controller, a MAC rotation manager component, a leader AP, an administrator of the network, any combination thereof, or the like) may identify AP 310 (as described in FIG. 3) as being in the neighborhood of AP 312 (as described in FIG. 3), a foreign AP.

In block 410, the MAC rotation strategy may include flagging the APs for stability. For example, AP 310 may be flagged for stability (e.g., maintain a stable BSSID).

In block 412, optionally, the MAC rotation strategy could include detecting one of the foreign APs. In some examples, AP 310 may detect AP 312, a foreign AP.

In block 414, the MAC rotation strategy could include applying a stable BSSID to the one or more APs. For example, a stable BSSID may be applied to AP 310. In some examples, applying a stable BSSID may be in response to detecting one of the foreign APs, as indicated above in block 412.

FIG. 4C illustrates an example flowchart for MAC address coordination procedure where a first plurality of APs rotates associated BSSIDs in relation to one or more phases of MAPC according to some aspects of the present disclosure. For example, APs associated with the network may include scheduled periods where MAC address rotation stops (e.g., during MAPC discovery, configuration, and operation phases. The local AP BSSID rotates in accordance with the MAPC operations, but a stable BSSID value is maintained during the MAPC discovery, configuration, and operation phases (where APs learn each other's service periods/SPs and schedule accordingly).

In block 416, a MAC rotation strategy may include determining phases of the MAPC between one or more APs. For example, AP 310 may determine phases of MAPC between AP 310 and AP 312.

In block 418, the MAC rotation strategy may apply a stable BSSID to a first AP during each phase of the MAPC. For example, AP 310 may apply the stable BSSID during each phase of MAPC with AP 312.

In block 420, the MAC rotation strategy may include determining if the discovery phase of MAPC has ended. For example, AP 310 may determine if the discovery phase of MAPC with AP 312 has ended. If the discovery phase has ended, in block 424, the MAC rotation strategy may include resuming BSSID rotation. For example, AP 310 may resume BSSID rotation at block 424.

If the discovery phase has not ended, at block 422, the MAC rotation strategy may include determining if the operation phase of MAPC has ended. For example, AP 310 may determine if the operation phase of MAPC with AP 312 has ended. If the operation phase has ended, AP 310 may resume BSSID rotation at block 424. If the operation phase has not ended, AP 310 may continue applying a stable BSSID during each phase of the MAPC with AP 312.

FIG. 4D illustrates an example flowchart for MAC address coordination procedure where a first plurality of APs utilizes one or more sets of BSSIDs according to some aspects of the present disclosure. For example, APs associated with the network may rotate through a pool of MAC addresses. A separate BSSID pool is used for inter-BSS/MAPC operations and specifically for foreign APs operations, where the local AP BSSID takes different values in a stable pool, but the pool is the same for all APs of the local system that are in contact with foreign APs. Thus, an observer can see a stable BSSID, but the location of the BSSID keeps changing as different APs use the value in turn.

In block 426, a MAC rotation strategy may include applying a stable BSSID from a first set of stable BSSIDs for the multi-AP coordination. For example, AP 310 (as described in FIG. 3) may apply a stable BSSID (according to the MAC rotation strategy) from the first set of stable BSSIDs for the MAPC with AP 312 (as described in FIG. 3).

In block 428, the MAC rotation strategy may include applying a BSSID that is from a second set of BSSIDs that is different from the first set of stable BSSIDs for the RCM operation. For example, AP 310 may apply the BSSID that is from the second set of BSSIDs that is different from the first set of stable BSSIDs for the RCM operation in accordance with the MAC rotation strategy.

FIG. 4E illustrates an example flowchart for MAC address coordination procedure where a first plurality of APs is associated with one or more algorithms of an RCM policy according to some aspects of the present disclosure. For example, APs associated with the network may be associated with an individual algorithm used to determine the MAC address rotation scheme. The local and the foreign WLAN exchange epoch (rotation schedule) and keys in advance of MAPC operation, allowing each to know when the other is rotating its BSSIDs, and what the next BSSID value will be.

In block 430, a MAC rotation strategy may include exchanging, between a first plurality of APs and a second plurality of APs, corresponding RCM policies prior to the MAPC, each of the corresponding RCM policies including a corresponding rotation schedule and corresponding keys for utilizing BSSIDs. For example, AP 310 (as described in FIG. 3) and AP 312 (as described in FIG. 3) may exchange respective RCM policies prior to the MAPC, where each of the respective RCM policies include a corresponding rotation schedule and corresponding keys for utilizing BSSIDs.

In block 432, the MAC rotation strategy may include performing the RCM operation and the MAPC based on the corresponding rotation schedule. For example, AP 310 and AP 312 may perform respective RCM operations and the MAPC based on the corresponding rotation schedule.

Further, block 432 may include block 434 and/or block 436.

In block 434, performing the RCM operation and the MAPC may include preventing changes to the BSSIDs for a duration of time around a scheduled operation for the MAPC, based on the corresponding rotation schedule. For example, AP 310 may prevent changes to the BSSIDs for the duration of time around the scheduled operation for the MAPC with AP 312, based on the corresponding rotation schedule.

Or, in some examples, in block 436, performing the RCM operation and the MAPC may include adjusting changes to the BSSIDs for a duration of time around a scheduled operation for the MAPC, based on the corresponding rotation schedule. For example, AP 310 may adjust changes to the BSSIDs for the duration of time around the scheduled operation for the MAPC with AP 312, based on the corresponding rotation schedule.

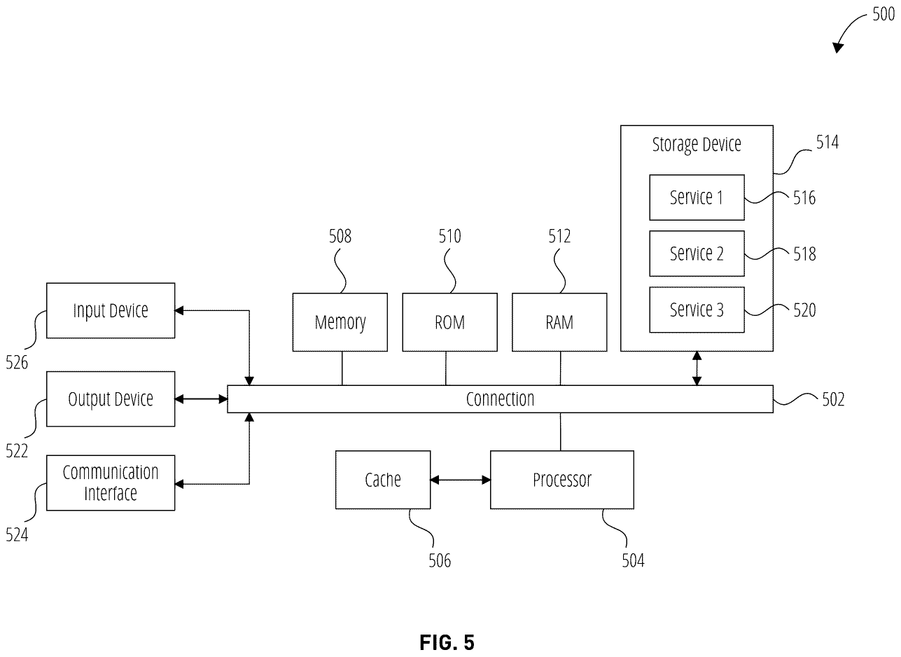

FIG. 5 shows an example of computing system 500, which can be for example any computing device making up the components of FIG. 1, FIG. 2A, and FIG. 2B, or any component thereof in which the components of the system are in communication with each other using connection 502. Connection 502 can be a physical connection via a bus, or a direct connection into processor 504, such as in a chipset architecture. Connection 502 can also be a virtual connection, networked connection, or logical connection.

In some embodiments, computing system 500 is a distributed system in which the functions described in this disclosure can be distributed within a datacenter, multiple data centers, a peer network, etc. In some embodiments, one or more of the described system components represent many such components each performing some or all of the functions for which the component is described. In some embodiments, the components can be physical or virtual devices.

Example computing system 500 includes at least one processing unit (CPU or processor) 504 and connection 502 that couples various system components including system memory 508, such as read-only memory (ROM) 510 and random-access memory (RAM) 512 to processor 504. Computing system 500 can include a cache of high-speed memory 506 connected directly with, in close proximity to, or integrated as part of processor 504.

Processor 504 can include any general-purpose processor and a hardware service or software service, such as services 516, 518, and 520 stored in storage device 514, configured to control processor 504 as well as a special-purpose processor where software instructions are incorporated into the actual processor design. Processor 504 may essentially be a completely self-contained computing system, containing multiple cores or processors, a bus, memory controller, cache, etc. A multi-core processor may be symmetric or asymmetric.

To enable user interaction, computing system 500 includes an input device 526, which can represent any number of input mechanisms, such as a microphone for speech, a touch-sensitive screen for gesture or graphical input, keyboard, mouse, motion input, speech, etc. Computing system 500 can also include output device 522, which can be one or more of a number of output mechanisms known to those of skill in the art. In some instances, multimodal systems can enable a user to provide multiple types of input/output to communicate with computing system 500. Computing system 500 can include communication interface 524, which can generally govern and manage the user input and system output. There is no restriction on operating on any particular hardware arrangement, and therefore the basic features here may easily be substituted for improved hardware or firmware arrangements as they are developed.

Storage device 514 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 514 can include software services, servers, services, etc., that when the code that defines such software is executed by the processor 504, it causes the system to perform a function. In some embodiments, a hardware service that performs a particular function can include the software component stored in a computer-readable medium in connection with the necessary hardware components, such as processor 504, connection 502, output device 522, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general-purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A computer-implemented method, comprising:
determining a Media Access Control (MAC) rotation strategy for a first plurality of access points (APs) of a first wireless network, wherein the MAC rotation strategy specifies use of Basic Service Set Identifiers (BSSIDs) by the first plurality of APs for implementing Randomized and Changing MAC (RCM) in presence of a second plurality of APs of a second wireless network;
performing the RCM based on the MAC rotation strategy; and
performing multi-AP coordination with the second plurality of APs using the BSSIDs.

2. The computer-implemented method of claim 1, wherein the MAC rotation strategy includes:
identifying at least one AP from among the first plurality of APs that is in proximity of at least one of the second plurality of APs; and
applying a stable BSSID at the first plurality of APs to implement the RCM when at least one end device is detected in association with one of the second plurality of APs.

3. The computer-implemented method of claim 1, wherein the MAC rotation strategy includes:
identifying at least one AP from among the first plurality of APs that is in proximity of at least one of the second plurality of APs; and
applying a stable BSSID at the first plurality of APs to implement the RCM.

4. The computer-implemented method of claim 1, wherein the MAC rotation strategy includes:
rotating the BSSIDs in relation to one or more phases of the multi-AP coordination between the first plurality of APs and the second plurality of APs, the one or more phases including a discovery phase, a configuration phase, and an operation phase.

5. The computer-implemented method of claim 1, wherein the MAC rotation strategy includes:
applying a first set of BSSIDs for the multi-AP coordination, wherein the first set of BSSIDs is identical for all APs of the first plurality of APs; and
applying a second set of BSSIDs that is different from the first set of BSSIDs for the RCM.

6. The computer-implemented method of claim 1, wherein the MAC rotation strategy includes:
exchanging, between the first plurality of APs and the second plurality of APs, corresponding RCM policies prior to the multi-AP coordination, each of the corresponding RCM policies including a corresponding rotation schedule and corresponding keys for utilizing BSSIDs; and
performing the RCM and the multi-AP coordination based on the corresponding rotation schedule.

7. The computer-implemented method of claim 6, further comprising at least one of:
preventing changes to the BSSIDs for a duration of time around a scheduled operation for the multi-AP coordination, based on the corresponding rotation schedule; or
adjusting the scheduled operation to prevent rotation of the BSSIDs, based on the corresponding rotation schedule.

8. An access point comprising:
one or more processors; and
a memory storing instructions that, when executed by the one or more processors, configure the access point to:
determine a Media Access Control (MAC) rotation strategy for a first plurality of access points (APs) of a first wireless network, wherein the MAC rotation strategy specifies use of Basic Service Set Identifiers (BSSIDs) by the first plurality of APs for implementing Randomized and Changing MAC (RCM) in presence of a second plurality of APs of a second wireless network;
perform the RCM based on the MAC rotation strategy; and
perform multi-AP coordination with the second plurality of APs using the BSSIDs.

9. The access point of claim 8, wherein the MAC rotation strategy includes:
identify at least one AP from among the first plurality of APs that is in proximity of at least one of the second plurality of APs; and
apply a stable BSSID at the first plurality of APs to implement the RCM when at least one end device is detected in association with one of the second plurality of APs.

10. The access point of claim 8, wherein the MAC rotation strategy further includes:
identify at least one AP from among the first plurality of APs that is in proximity of at least one of the second plurality of APs; and
apply a stable BSSID at the first plurality of APs to implement the RCM.

11. The access point of claim 8, wherein the MAC rotation strategy further includes:
rotate the BSSIDs in relation to one or more phases of the multi-AP coordination between the first plurality of APs and the second plurality of APs, the one or more phases including a discovery phase, a configuration phase, and an operation phase.

12. The access point of claim 8, wherein the MAC rotation strategy further includes:
apply a first set of BSSIDs for the multi-AP coordination, wherein the first set of BSSIDs is identical for all APs of the first plurality of APs; and
apply a second set of BSSIDs that is different from the first set of BSSIDs for the RCM.

13. The access point of claim 8, wherein the MAC rotation strategy includes:
exchange, between the first plurality of APs and the second plurality of APs, corresponding RCM policies prior to the multi-AP coordination, each of the corresponding RCM policies including a corresponding rotation schedule and corresponding keys for utilizing BSSIDs; and
perform the RCM and the multi-AP coordination based on the corresponding rotation schedule.

14. The access point of claim 13, further comprising at least one of:
prevent changes to the BSSIDs for a duration of time around a scheduled operation for the multi-AP coordination, based on the corresponding rotation schedule; or
adjust the scheduled operation to prevent rotation of the BSSIDs, based on the corresponding rotation schedule.

15. One or more non-transitory computer-readable media comprising computer-readable instructions, which when executed by one or more processors of an access point, cause the access point to:
determine a Media Access Control (MAC) rotation strategy for a first plurality of access points (APs) of a first wireless network, wherein the MAC rotation strategy specifies use of Basic Service Set Identifiers (BSSIDs) by the first plurality of APs for implementing Randomized and Changing MAC (RCM) in presence of a second plurality of APs of a second wireless network;
perform the RCM based on the MAC rotation strategy; and
perform multi-AP coordination with the second plurality of APs using the BSSIDs.

16. The one or more non-transitory computer-readable media of claim 15, wherein the MAC rotation strategy further includes:
identify at least one AP from among the first plurality of APs that is in proximity of at least one of the second plurality of APs; and
apply a stable BSSID at the first plurality of APs to implement the RCM when at least one end device is detected in association with one of the second plurality of APs.

17. The one or more non-transitory computer-readable media of claim 15, wherein the MAC rotation strategy further includes:
identify at least one AP from among the first plurality of APs that is in proximity of at least one of the second plurality of APs; and
apply a stable BSSID at the first plurality of APs to implement the RCM.

18. The one or more non-transitory computer-readable media of claim 15, wherein the MAC rotation strategy further includes:
rotate the BSSIDs in relation to one or more phases of the multi-AP coordination between the first plurality of APs and the second plurality of APs, the one or more phases including a discovery phase, a configuration phase, and an operation phase.

19. The one or more non-transitory computer-readable media of claim 15, wherein the MAC rotation strategy further includes:
apply a first set of BSSIDs for the multi-AP coordination, wherein the first set of BSSIDs is identical for all APs of the first plurality of APs; and
apply a second set of BSSIDs that is different from the first set of BSSIDs for the RCM.

20. The one or more non-transitory computer-readable media of claim 15, wherein the MAC rotation strategy includes:
exchange, between the first plurality of APs and the second plurality of APs, corresponding RCM policies prior to the multi-AP coordination, each of the corresponding RCM policies including a corresponding rotation schedule and corresponding keys for utilizing BSSIDs; and
perform the RCM and the multi-AP coordination based on the corresponding rotation schedule.
